(19) United States
(12) Patent Application Publication
(10) Pub. No.: US 2013/0331303 A1
(43) Pub. Date: Dec. 12, 2013

(54) FLAT RHEOLOGY WELLBORE FLUID

(71) Applicants: Nathan Rife, Sugar Land, TX (US); Steven Young, Cypress, TX (US); Lijein Lee, Sugar Land, TX (US)

(72) Inventors: Nathan Rife, Sugar Land, TX (US); Steven Young, Cypress, TX (US); Lijein Lee, Sugar Land, TX (US)

(73) Assignee: M-I L.L.C., Houston, TX (US)

(21) Appl. No.: 13/807,655

(22) PCT Filed: Jun. 30, 2011
(86) PCT No.: PCT/US11/42606

§ 371 Date: Aug. 28, 2013

Related U.S. Application Data
(60) Provisional application No. 61/360,391, filed on Jun. 30, 2010.

(51) Int. Cl. C09K 8/36

(52) U.S. Cl. CPC C09K 8/36
USPC 507/131

(57) ABSTRACT

Wellbore fluids comprising a flat rheology profile are disclosed herein. In one aspect, the invert emulsion wellbore fluid is formulated to include: an oleallinous fluid as the continuous phase of the invert emulsion well bore fluid, a non-oleaginous fluid as the discontinuous phase of the invert emulsion well bore fluid; an emulsifier; and a rheology modifier, wherein the rheology modifier is a polyamide formed by reacting an alcoholamine, a fatty acid, and polyamine, where the invert emulsion well bore fluid has a flat rheology profile.

### BACKGROUND

In drilling of subterranean wells numerous functions and characteristics are expected of a drilling fluid. A drilling fluid should circulate throughout the well and carry cuttings from beneath the bit, transport the cuttings up the annulus, and allow separation at the surface. At the same time, the drilling fluid is expected to cool and clean the drill bit, reduce friction between the drill string and the sides of the hole, and maintain stability in the borehole's cased sections. The drilling fluid should also form a thin, low permeability filter cake that seals openings in formations penetrated by the bit and act to reduce the unwanted influx of formation fluids from permeable rocks.

Drilling fluids are typically classified according to their base material; in oil base fluids, solid particles are suspended in oil, and water or brine may be emulsified with the oil. The oil is typically the continuous phase. In water base fluids, solid particles are suspended in water or brine, and oil may be emulsified in the water. The water is typically the continuous phase. Pneumatic fluids are a third class of drilling fluids in which a high velocity stream of air or natural gas removes drill cuttings.

Oil-based drilling fluids are generally used in the form of invert emulsion fluids. An invert emulsion mud consists of three-phases: an oleaginous phase, a non-oleaginous phase and a finely divided particle phase. Optionally included are emulsifiers and emulsifier systems, weighting agents, fluid loss additives, alkalinity regulators and the like, for stabilizing the system as a. whole and for establishing the desired performance properties.

It is important that the driller of subterranean wells be able to control the rheological properties of drilling fluids. In the oil and gas industry today it is desirable that additives work both onshore and offshore and in fresh and salt water environments. In addition, drilling fluid additives should have low toxicity levels and should be easy to handle and to use to minimize the dangers of environmental pollution and harm to operators. Any drilling fluid additive should also provide the desired results, but at the same time the additive should not inhibit the desired performance of other components of the drilling fluid.

### SUMMARY

In one aspect, disclosures herein relate to an invert emulsion well bore fluid formulated to include: an oleaginous fluid as the continuous phase of the invert emulsion wellbore fluid; a non-oleaginous fluid as the discontinuous phase of the invert emulsion wellbore fluid; an emulsifier; and a rheology modifier, wherein the rheology modifier is a polyamide formed by reacting an alcohol amine, a fatty acid, and polyamine, where the invert emulsion well bore fluid has a flat rheology profile.

In another aspect, disclosures herein relate to a method for drilling a subterranean well comprising circulating an invert emulsion well bore fluid in a well bore, wherein the invert emulsion well bore fluid comprises: an oleaginous fluid as the continuous phase of the invert emulsion well bore fluid; a non-oleaginous fluid as the discontinuous phase of the invert emulsion well bore fluid; an emulsifier; and a rheology modifier; where the invert emulsion well bore fluid has a flat rheology profile.

Other aspects and advantages will be apparent from the following description and the appended claims.

### BRIEF DESCRIPTION OF THE DRAWINGS

FIG. 1 is a graphical comparison of rheology profiles of unweighted fluids.

FIG. 2 is a graphical comparison of the 6-rpm and Yield Point data from the fluids depicted in FIG. 1.

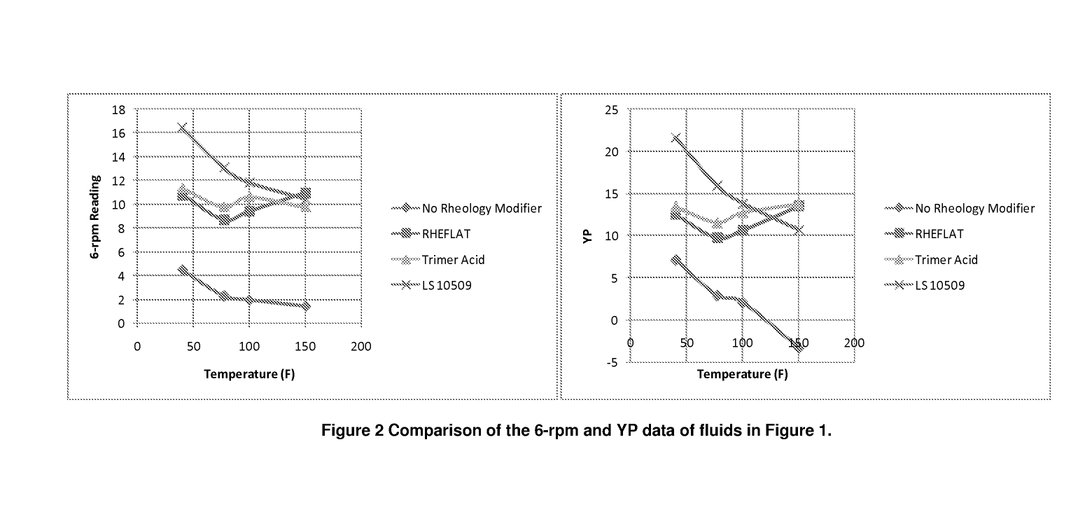

### DETAILED DESCRIPTION

The present disclosure is generally directed to an oil base well bore fluid that is useful in the formulation of drilling, completing and working over of subterranean wells, preferably oil and gas wells. The fluids may also be used as packing fluids, fracturing fluids and other similar well bore uses in which flat rheology properties are desired. Various uses of well bore fluids are noted in the book COMPOSITION AND PROPERTIES OF DRILLING AND COMPLETION FLUIDS, 5th Edition, H. C. H. Darley and George R, Gray, Gulf Publishing Company, 1 988, the contents of which are hereby incorporated herein by reference.

As disclosed herein, well bore fluids having flat rheology profiles are formulated to include an oleaginous fluid, a non-oleaginous fluid, a primary emulsifier, and a rheology modifier. Each of these components is disclosed in greater detailed below. As used herein, “flat rheology profile” means that consistent rheological properties are maintained over temperature ranges from 40° F. to 150° F. The rheological properties of focus for a flat rheology profile include 6 rpm, 10 minute gel (10′), Yield Point (YP), and 10 minute-to-10 second gel ratio (10′:10″ gel ratio). With respect to 6 rpm, 10′ gel, and YP, a system is considered to have a flat rheology profile when these values are within +/−20% of the mean values across temperature ranges from 40° F. to 150° F. In other words, where a fluid has the following 6 rpm values: 20 (40° F.), 16 (100° F.), and 15 (150° F.), then the mean 6 rpm is 17. Accordingly, each 6 rpm value is within +/−20% of the mean value. Lower percent variation will yield a more flat rheology profile, so values within +/−15% is preferred, and +/−10% is even more preferred. With respect to 10′:10″ gel ratio, a system is considered to have a flat rheology profile when the ratio is 1.5:1 or less. To best optimize the flat rheology profile, the 6 rpm, 10 minute gel, Yield Point, and 10′:10″ ratio properties should concurrently fall within these parameters.

The oleaginous fluid may be is a liquid and more specifically is a natural or synthetic oil. The oleaginous fluid may be selected from the group consisting of diesel oil; mineral oil; synthetic oil (such as polyolefins, polydiorganosiloxanes, siloxanes or organosiloxanes); and mixtures thereof. The concentration of the oleaginous fluid should be sufficient so that an invert emulsion forms. The concentration of the oleaginous fluid may be less than about 99% by volume of the invert emulsion. In one embodiment the amount of oleaginous fluid is from about 30% to about 95% by volume and more preferably about 40% to about 90% by volume of the invert emulsion fluid.

The oleaginous fluid may include a mixture of internal olefin and alpha olefins. A combination of internal and alpha olefins can be used to create a drilling, fluid having a balance of desirable properties such as toxicity and biodegradability. As an example, a mixture of a C₁₆₋₁₈ internal olefin; a C₁₅₋₁₈ internal olefin; a C₁₅₋₁₆ internal olefin and a C₁₆ alpha olefin is made with a weight ratio of 5/2/1.5/1.5 respectively. This results in an oleaginous fluid having a balance of toxicity and biodegradability properties.

The non-oleaginous fluid used in the formulation of the invert emulsion fluid may be a liquid, and preferably is an aqueous liquid. The non-oleaginous liquid may be selected from the group consisting of fresh water, sea water, a brine containing organic and/or inorganic dissolved salts, liquids containing water-miscible organic compounds, combinations of these and similar compounds used in the formulation of invert emulsions. The amount of the non-oleaginous fluid is typically less than the theoretical maximum limit for forming an invert emulsion. Thus, the amount of non-oleaginous fluid is less than about 70% by volume. Preferably, the amount of non-oleaginous fluid ranges from about 1% to about 70% by volume, and more preferably from about 5% to about 60% by volume of the invert emulsion fluid.

The emulsifier, utilized in the formulation of a well bore fluid in accordance with the teachings of the present disclosure, should be selected so as to form a useful and stable invert emulsion suitable for drilling. The emulsifier should be present in a concentration sufficient to for a stable invert emulsion that is useful for drilling. In one illustrative embodiment, the emulsifier has a concentration from about 7 pounds per barrel (ppb) to about 11 ppb. More preferably, the emulsifier has a concentration of about 8 ppb to about to ppb. The emulsifiers that have demonstrated utility in the emulsions of this disclosure are fatty acids, soaps of fatty acids amidoamines, polyamides, polyamines, oleate esters, such as sorbitan monoleate, sorbitan dioleate, imidazoline derivatives or alcohol derivatives and combinations or derivatives of the above. Amidoamines that provide fluids with flat rheology profiles may include amidoamines formed from reacting fatty acids with alkylamines. Fatty acids of the present disclosure may be selected from the group consisting of oleic acid, palmitic acid, linoleic acid, tall oil fatty acids (TOFA), and combinations thereof. Alkylamines of the present disclosure may be selected from the group consisting of diethylene triamine, triethylene tetramine, tetraethylene pentamine, and combinations thereof. Blends of these materials as well as other emulsifiers can be used for the flat rheology fluids of the present disclosure.

The rheology modifier of the present disclosure is utilized to reduce the increase in viscosity, i.e. flatten the rheological characteristics, of the drilling fluid over a temperature range from about 40° F. to about 150° F. The rheology modifier may be a polyamides, polyamines, or mixtures thereof. The polyamides of the present disclosure are derived from reacting a polyamine with the reaction product of an alcoholamine and a fatty acid. Generally, the alcoholamine-fatty acid reaction is based on a one equivalent of fatty acid for each equivalent of alcoholamine present. This reaction product is then reacted on a 1:1 equivalent ratio with the polyamine, and then quenched with a propylenecarbonate to removed any free unreacted amines. With respect to the rheology modifier, alcoholamines of the present disclosure may be selected from the group consisting of monoethanolamine, diethanolamine, triethanolamine, and mixtures thereof. Fatty acids may include tall oil or other similar unsaturated long chain carboxylic acids having from about 12 to about 22 carbon atoms. The fatty acids may be dimer or trimer fatty acids, or combinations thereof. As previously mentioned, once the alcoholamine has been reacted with the fatty acid, the reaction product is then further reacted with a polyamine. With respect to the rheology modifier, polyamines may be selected from the group consisting of diethylene triamine, triethylene tetramine, tetraethylene pentamine, and combinations thereof. Commercially available rheology modifiers that provide flat rheology wellbore fluids include EMI-1005, available from M-I SWACO (Houston, Tex.), and TECHWAX™ LS-10509 and LS-20509, both available from International Specialty Products (Wayne, N.J.).

The concentration of the rheology modifier should be sufficient to achieve the flat rheology profile as described herein. The concentration of the rheology modifier may range from about 0.1 to 5 pounds per barrel of wellbore fluid, and more preferably is from about 0.5 to 1.5 pounds per barrel of well bore fluid.

Although not wishing to be bound by any specific theory of action, it is believed that the relatively flat rheology profiles achieved by the present invention are the result of the interaction of the rheology modifier with the fine solids, such as organophilic clays and low-gravity solids present in the drilling fluid. It is believed that the interaction is somewhat temperature motivated in such a way that the enhancement is greater at higher temperatures and weaker at lower temperatures. One theory is that the change in temperature causes a change in the molecular confirmation of the rheology modifier such that at higher temperatures more molecular interactions and thus higher viscosity than is observed at lower temperatures. Alternatively, it is speculated that absorption/desorption of the rheology modifier onto the surfaces of the solids present in the fluid is related to the viscosity properties observed. Regardless of the mode of action, it has been found that the addition of the rheology modifiers, as disclosed herein, to well bore fluids results in the viscosity properties observed and disclosed below.

The disclosed wellbore fluids are especially useful in the drilling, completion and working over of subterranean oil and gas wells. In particular the fluids are useful in formulating drilling fluids and completion fluids for use in high deviation wells, and long reach wells. Such fluids are especially useful in the drilling of horizontal wells into hydrocarbon bearing formations.

The method used in preparing the drilling fluids currently disclosed is not critical. Conventional methods can be used to prepare the drilling fluids of the present invention in a manner analogous to those normally used, to prepare conventional oil-based drilling fluids. In one representative procedure, a desired quantity of oleaginous fluid such as a base oil and a suitable amount of the primary emulsifier are mixed together, followed by the rheology modifying agent and the remaining components are added with continuous mixing. An invert emulsion. based on this fluid may be formed by vigorously agitating, mixing or shearing the oleaginous fluid with a non-oleaginous fluid.

Importantly, the fluids of the present invention do not require additional agents to achieve a flat rheology profile. Applicants have surprisingly found that a unique combination of an oleaginous fluid, non-oleaginous fluid, emulsifier, and rheology modifier can provide the desired flat rheology profile. Applicants have also found that the rheology profile can be optimized by further containing viscosifying agents and fluid loss control agents.

Viscosifiers of the present invention may include organophilic clays, which are normally pre-treated amine clays. The viscosifying agent may be dispersed in the oleaginous phase of the wellbore fluid compositions of the present disclosure, Suitable organophilic clay viscosifiers may include amine-treated bentonite, hectorite, attapulgite, and the like. For most invert emulsion applications, the amount of organophilic clay used in the wellbore fluid formulation may be in the range of about 0.1 ppb to about 5 ppb of the wellbore fluid. Commercially available organophilic clays include VG-69, VG PLUS, VG SUPREME, and Versa-HRP, all available from M-I SWACO (Houston, Tex.).

Fluid loss control agents typically act by coating the walls of the borehole as the well is being drilled. Exemplary fluid loss control agents which may find utility in this invention include modified lignites, asphaltic compounds, gilsonite, organophilic humates prepared by reacting huinic acid with amides or polyalkylene polyamines, and other non-toxic fluid loss additives. Typically, fluid loss control agents are added in amounts less than about 10% and preferably less than about 5% by weight of the fluid. ECOTROL RD™ is an exemplary commercially available fluid loss control agent from M-I SWACO (Houston, Tex.).

The fluids of the present disclosure may further contain additional components depending upon the end use of the invert emulsion so long as they do not interfere with the flat rheology profile described herein. For example, alkali reserve, wetting agents, weighting agents, and bridging agents may be added to the fluid compositions for additional functional properties. The addition of such. agents may vary depending upon the application, and should be modifiable by one of skill in the art of formulating wellbore fluids.

It is conventional in many invert emulsions to include an alkali reserve so that the overall fluid formulation is basic (i.e. pH greater than 7). Typically this is in the form of lime or alternatively mixtures of alkali and alkaline earth oxides and hydroxides. One of skill in the art should understand and appreciate that the lime content of a well bore fluid will vary depending upon the operations being undertaken and the formations being drilled. Further it should be appreciated that the lime content, also known as alkalinity or alkaline reserve, is a property that is typically measured in accordance with the applicable API standards which utilize methods that should be well know to one of skill in the art of fluid formulation.

Wetting agents that may be suitable for use include, crude tall oil, oxidized crude tall oil, organic phosphate esters, modified imidazolines and amidoamines, alkyl aromatic sulfates and sulfonates, and the like, and combinations or derivatives of these. Faze-Wet™, VersaCoat™, SureWet™, Versawet®, and Versawet®NS are examples of commercially available wetting agents manufactured and distributed by M-I SWACO (Houston, Tex.) that may be used in the disclosed well bore fluids. Silwet L-77, L-7001, L7605 and L-7622 are examples of commercially available surfactants and wetting agents manufactured and distributed by General Electric Company (Wilton, Conn.)

Weighting agents or density materials suitable for use in the described well bore fluids include galena, hematite, magnetite, iron oxides, ilimenite, barite, siderite, celestite, dolomite, calcite, and the like. The quantity of such material added, if any, depends upon the desired density of the final composition. Typically, weight material is added to result in a drilling fluid density of up to about 24 pounds per gallon. The weight material is preferably added up to 21 pounds per gallon and most preferably up to 19.5 pounds per gallon,

The following examples are included to demonstrate the claimed subject matter. It should be appreciated by those of skill in the art that the techniques and compositions disclosed in the examples which follow represent techniques discovered by the inventors to function well and thus can be considered to constitute preferred modes of practice. However, those of skill in the art should, in light of the present disclosure, appreciate that many changes can be made in the specific embodiments which are disclosed and still obtain a like or similar result without departing from the scope of the claimed subject matter.

General Information Relevant to the Examples:

Fluids were prepared by mixing on Hamilton Beach and Silverson mixers. A sample flat rheology fluid was initially prepared to serve as a control fluid. This control fluid, along with the Hamilton Beach mixing times, are provided below in Table 1. As shown in the formulation, HMP was used to simulate drill solids. Once the components were mixed, the fluid would then be sheared at 6000 rpm for 10 minutes on the Silverson mixer.

TABLE 1
Control Formulation and Mixing Times

| Product | ppb | Mixing Time |
|---|---|---|
| Synthetic Base Oil | 141.1 | |
| Organophilic Clay | 0.5 | |
| Rheological Additive | — | 10 |
| Lime | 4.0 | 5 |
| Emulsifier | 10.0 | |
| Wetting Agent | 2.0 | 5 |
| Fluid Loss Control Agent | 0.5 | 5 |
| 20% CaCl2 Brine | 61.0 | 10 |
| Water | 46.8 | |
| 86% CaCl2 | 14.2 | |
| Barite | 389.2 | 5 |
| Polymeric Rheology Modifier | 0.25 | |
| Viscosifier | 1.25 | 5 |
| HMP | 20 | 10 |

The fluids were heat aged for 16 hours at 250° F., unless otherwise specified. After aging, the fluids were allowed to cool to room temperature and then sheared for 10 min on the Hamilton Beach mixer before obtaining rheology measurements. Rheology was measured before and/or after hot rolling as indicated in the examples below. After hot rolling, the Electric Stability (ES) was measured at ambient temperature and HTHP fluid loss was determined at 200° F., 500 psi.

Testing for “flat” characteristics consisted of measuring the rheology over the temperature range 40-150° F. to determine the 6-rpm, YP, 10′ gel, and the 10′/10″ gel ratio of the test fluids.

Reproducibility of rheology measurements on the same fluid could be affected by the following: time-at-rest of the sample before rheology measurements, duration and intensity of shearing before measurements, and small variations in temperature in the cold-temperature measurements. To minimize variations and ensure reproducibility, the following procedure was adopted:
1. Prepare fluids according to the mixing times as shown in Table 1.
2. Hot roll samples for 16 hours at specified temperature.
3. Cool samples for one hour after hot rolling.
4. Shear samples on Hamilton Beach mixer for 5 minutes, and then immediately transfer to thermo-cup(s).
5. If sample has to wait for the 40° F. measurement, ensure they are sheared for 5 minutes before transferring to the low-temp thermo-cup.
6. Start measurements as soon as sample reaches test temperature.

TABLE 2
Properties of Control Fluid

| | AHR at 250 F. | | |
|---|---|---|---|
| Properties | 40 F. | 100 F. | 150 F. |
| 600 | 174 | 90 | 70 |
| 300 | 102 | 56 | 48 |
| 200 | 77 | 45 | 39 |
| 100 | 51 | 33 | 30 |
| 6 | 20 | 16 | 15 |
| 3 | 18 | 15 | 14 |
| 10″ gel | 22 | 19 | 17 |
| 10′ gel | 25 | 28 | 22 |
| PV | 72 | 34 | 20 |
| YP | 30 | 22 | 28 |
| ES | 1244 | | |
| HTHP @ 250 F. | 2 | | |
| Gel Ratio | 1.1 | 1.5 | 1.3 |

“PV” is plastic viscosity, which is one variable used in the calculation of viscosity characteristics of a drilling fluid, measured in centipoise (cp) units.
“YP” is yield point, which is another variable used in the calculation of viscosity characteristics of drilling fluids, measured in. pounds per 100 square feet (Ibi1 00 ft\grave{ }).
“AV” is apparent viscosity, which is another variable, used in the calculation of viscosity characteristic of drilling fluid, measured in cemipoise (cp) units.
“GELS” is a measure of the suspending characteristics, or the thixotripic properties of a drilling fluid, measured in pounds per 100 square feet (1b1100
“API F1.” is the term used for API filtrate loss in milliliters (m1).
“HTHP” is the term used for high-temperature high-pressure fluid loss, measured in milliliters (ml) according to API bulletin RP 13 8-2, 1990.

The components of the claimed drilling fluids include oleaginous fluid, a non-oleaginous fluid, an emulsifier package and a rheology modifier. Other chemicals used to make-up the system are basically the same as those typically used in formulating conventional invert drilling fluid systems.

### EXAMPLES

Rheology modifiers were analyzed for providing the fluid system with a flat rheology profile. Table 3 provides an unweighted base formulation that was tested using the test method provided above. VG PLUS is a organophilic bentonite clay; VG SUPREME is an organophilic bentonite clay; SUREMUL is a fatty acid based emulsifier; SUREWET is an amidoamine based wetting agent; ECOTROL is a polymeric fluid loss control agent; RHEFLAT is a rheology modifier that is a mix of poly fatty acids; RHETHIK is a polymeric viscosifier; and EMI-1005 is a mixed polyamine/polyamide rheology modifier; all are commercially available from M-I SWACO (Houston, Tex.). LS-10509 is an amidoamine/trimer ace in kerosene, and LS-20509 is an polyamidoamine, both of which are available from International Specialty Products (Wayne, N.J.)

TABLE 3
Formulation for Unweighted Fluid
with Various Rheology Modifiers

| Product | ppb |
|---|---|
| Synthetic Base Oil | 176.3 |
| VG PLUS | 2.4 |
| VG SUPREME | 0.8 |
| Lime | 4.0 |
| SUREMUL | 7.0 |
| SUREWET | 2.0 |
| EcoTrol RD | 0.5 |
| 20% CaCl2 Brine | 127.4 |
| Water | 97.8 |
| 86% CaCl2 | 29.6 |
| Barite | — |
| Rheology Modifier | 2.0 |
| HMP | — |

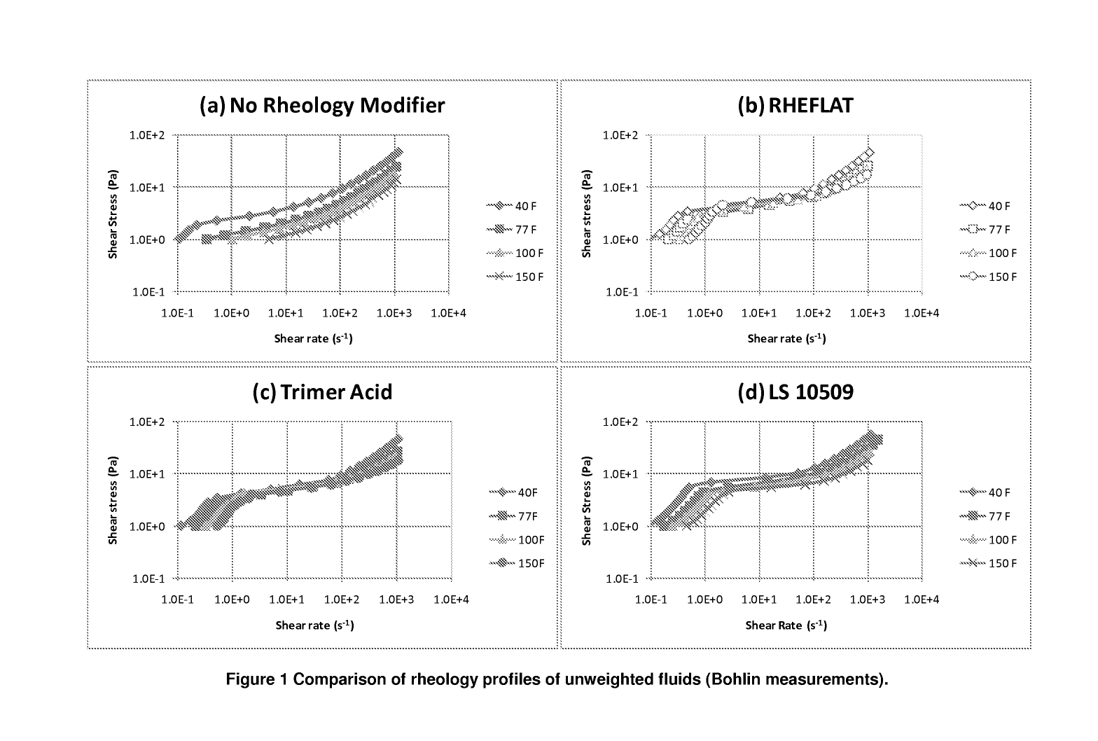

Four systems were reviewed for the flat rheology profile, and are depicted in FIG. 1 (a)-(d). The systems were evaluated by rheology measurement on the Bohlin Gemini 150 rheometer at 40 F, 77 F, 100 F, and 150 F. The measurements revealed the potential of rheology modifiers to produce near-constant rheology over a range of shear rates. Rheology modifiers considered include (b) RHEFLAT, (c) trimer fatty acid, and (d) LS 10509. For comparison purposes, fluid system (a) did not include a rheology modifier.

As shown in Error! Reference source not found., the rheology profiles differ significantly when there is no rheology modifier in the fluid (a). With RHEFLAT, the profiles show near-constant rheology in the shear arte range 1-100 s⁻¹ (b). Similarly, additive Trimer Acid generates profiles that are constant in the mid shear rate range (c). In contrast, additive LS 10509 appears to be less effective in keeping the rheology constant (d).

Using shear-rate interpolation, the Bohlin measurements were converted to Fann-equivalent data for comparison of the 6 rpm and YP values of the additives over the temperature range. Examples of this comparison are shown Error! Reference source not found. It can be seen that both RHEFLAT and Trimer Acid improve the flatness of the 6-rpm and YP profiles in the 40-150° F. temperature range while LS 10509 has less flattening effect.

Three fluid systems were formulated as 70/30 oil-to-water ratio, 15 ppg systems consistent with the invert emulsion base fluids and procedures described above. These fluids systems compared the additive compositions and concentrations to evaluate the impact of rheology modifiers on the rheology profile of the systems. The additive formulations and rheology profiles are detailed below in Tables 4 and 5.

TABLE 4
Formulations of Fluid Systems With Various Rheology Modifiers

| | Fluid A | Fluid B | Fluid C |
|---|---|---|---|
| Product | (ppb) | (ppb) | (ppb) |
| VG PLUS | 0.5 | 0.5 | 1.0 |
| VG SUPREME | — | — | — |
| Lime | 4.0 | 4.0 | 4.0 |
| Emulsifier | 12.0 | 12.0 | 12.0 |
| SUREWET | 2.0 | 2.0 | — |
| EcoTrol RD | 0.5 | 0.5 | — |
| LS 20509 | 1.0 | 1.0 | — |
| EMI-1005 | — | 0.5 | 1.0 |
| HMP | 20.0 | 20.0 | 20.0 |

TABLE 5
Rheology for Fluid Systems A-C

| | Fluid A | | | Fluid B | | | Fluid C | | |
|---|---|---|---|---|---|---|---|---|---|
| Properties | 40 F. | 100 F. | 150 F. | 40 F. | 100 F. | 150 F. | 40 F. | 100 F. | 150 F. |
| 6 | 18 | 15 | 12 | 15 | 14 | 14 | 10 | 10 | 10 |
| 10′ gel | 38 | 25 | 17 | 36 | 23 | 21 | 17 | 16 | 16 |
| YP | 27 | 26 | 20 | 25 | 28 | 23 | 16 | 19 | 21 |
| Gel Ratio | 1.5 | 1.4 | 1.3 | 1.6 | 1.3 | 1.3 | 1.3 | 1.3 | 1.5 |

Four fluid systems were formulated to evaluate the effect of various additives and concentrations on the rheology profile of the systems. Fluid D provides a general formulation for known flat rheology systems; Fluid E provides a general formulation for an alternate emulsifier; Fluid F provides a general formulation for a system incorporating the alternate emulsifier, and removing an additive from the system; and Fluid G provides a general formulation with the alternate emulsifier and lower concentrations of some of the additives. The formulations are set forth in Table 4 below.

TABLE 6
Formulations of Fluids With Various Emulsifiers

| Product | D (ppb) | E (ppb) | F (ppb) | G (ppb) |
|---|---|---|---|---|
| Synthetic Base Oil | 142 | 142 | 142 | 142 |
| VG PLUS | 1.5 | 1.5 | 1.0 | 1.0 |
| VG SUPREME | 0.5 | 0.5 | — | — |
| Lime | 3 | 3 | 3 | 3 |
| SUREMUL | 8.0 | — | — | — |
| EMI-2220 | 8 | 10 | 10 | 10 |
| SUREWET | 2.0 | 2.0 | 2.0 | 2.0 |
| EcoTrol RD | 0.5 | 0.5 | 0.5 | 0.5 |
| 25% CaCl2 Brine | 104 | 104 | 104 | 104 |
| Barite | 283 | 283 | 283 | 283 |
| RHEFLAT | 1.5 | 1.5 | 1.5 | 0.5 |
| RHETHIK | 0.5 | 0.5 | 0.5 | 0.1 |
| OCMA | 25.0 | 25.0 | 25.0 | 25.0 |

The rheology for the above formulations is provided in Tables 5-8 below. As evidenced by these results, choice of emulsifier can impact the ability to achieve and maintain a flat rheology profile for a fluid system across a 40° F. to 150° F. temperature range. Fluids D and E show the different rheology profiles between different emulsifiers, while Fluids F and G show the impact on the rheology profile of removing clays and reducing the concentration of rheology modifier and polymeric viscosifier.

TABLE 7
Rheology for Fluid D

| | AHR at 250 F. | | |
|---|---|---|---|
| Properties | 40 F. | 100 F. | 150 F. |
| 600 | 236 | 113 | 83 |
| 300 | 136 | 66 | 59 |
| 200 | 99 | 51 | 49 |
| 100 | 60 | 35 | 39 |
| 6 | 18 | 16 | 25 |
| 3 | 17 | 16 | 25 |
| 10″ gel | 24 | 26 | 30 |
| 10′ gel | 53 | 31 | 35 |
| PV | 100 | 47 | 24 |
| YP | 36 | 19 | 35 |
| ES | 469 | | |
| HTHP @ 250 F. | 2.2 | | |
| Gel Ratio | 2.2 | 1.2 | 1.2 |

TABLE 8
Rheology for Fluid E

| | AHR at 250 F. | | |
|---|---|---|---|
| Properties | 40 F. | 100 F. | 150 F. |
| 600 | 214 | 107 | 83 |
| 300 | 125 | 63 | 56 |
| 200 | 90 | 47 | 48 |
| 100 | 52 | 32 | 36 |
| 6 | 14 | 14 | 23 |
| 3 | 13 | 13 | 23 |
| 10″ gel | 20 | 25 | 30 |
| 10′ gel | 41 | 34 | 37 |
| PV | 89 | 44 | 27 |
| YP | 36 | 19 | 29 |
| ES | 617 | | |
| HTHP @ 250 F. | 2.2 | | |
| Gel Ratio | 2.1 | 1.4 | 1.2 |

TABLE 9
Rheology for Fluid F

| | AHR at 250 F. | | |
|---|---|---|---|
| Properties | 40 F. | 100 F. | 150 F. |
| 600 | 184 | 90 | 72 |
| 300 | 101 | 54 | 50 |
| 200 | 72 | 42 | 41 |
| 100 | 42 | 30 | 31 |
| 6 | 12 | 14 | 18 |
| 3 | 11 | 13 | 17 |
| 10″ gel | 19 | 22 | 25 |
| 10′ gel | 28 | 30 | 29 |
| PV | 83 | 36 | 22 |
| YP | 18 | 18 | 28 |
| ES | 698 | | |
| HTHP @ 250 F. | 4.8 | | |
| Gel Ratio | 1.5 | 1.4 | 1.2 |

TABLE 10
Rheology for Fluid G

| | AHR at 250 F. | | |
|---|---|---|---|
| Properties | 40 F. | 100 F. | 150 F. |
| 600 | 244 | 110 | 76 |
| 300 | 145 | 64 | 49 |
| 200 | 106 | 48 | 39 |
| 100 | 63 | 31 | 28 |
| 6 | 14 | 11 | 13 |
| 3 | 12 | 11 | 12 |
| 10″ gel | 16 | 14 | 14 |
| 10′ gel | 23 | 18 | 18 |
| PV | 99 | 46 | 27 |
| YP | 46 | 18 | 22 |
| ES | 376 | | |
| HTHP @ 250 F. | 5.2 | | |
| Gel Ratio | 1.4 | 1.3 | 1.3 |

While the apparatus, compositions and methods disclosed above have been described in terms of preferred or illustrative embodiments, it will be apparent to those of skill in the art that variations may be applied to the process described herein without departing from the concept and scope of the claimed subject matter All such similar substitutes and modifications apparent to those skilled in the art are deemed to be within the scope and concept of the subject matter as it is set out in the following claims.

1. An invert emulsion well bore fluid comprising:
an oleanginous fluid, wherein the oleaginous fluid is the continuous phase of the well bore fluid;
a non-oleaginous fluid, wherein the non-oleaginous fluid is the discontinuous phase of the well bore fluid;
an emulsifier, wherein the emulsifier is an amidoamine formed from the reaction of a fatty acid with an alkylamine, wherein the fatty acid is selected from the group consisting of oleic acid, palmitic acid, linoleic acid, tall oil fatty acids (TOFA), and combinations thereof; and
a rheology modifier, wherein the rheology modifier is a polyamide formed by the reaction of a polyamine with the reaction product of an alcoholamine and a fatty acid;

2. (canceled)

3. The invert emulsion well bore fluid of claim 1, wherein the rheology modifier comprises a polyamine selected from the group consisting of diethylenetriamine, triethylenetetramine, tetraethylenepentamine, and combinations thereof.

4. The invert emulsion well bore fluid of claim 1, wherein the rheology modifier comprises an alcoholamine selected from the group consisting of monoethanolamine, diethanolamine, and triethanolamine.

5. The invert emulsion wellbore fluid of claim 1, wherein the rheology modifier comprises a fatty acid that is a dimer or trimer fatty acid, or combinations thereof.

6. (canceled)

7. (canceled)

8. The invert emulsion well bore fluid of claim 1, wherein the alkylamine is selected from the group consisting of diethylene triamine, triethylene tetramine, tetraethylene pentamine, and combinations thereof.

9. The invert emulsion well bore fluid of claim 1, wherein the well bore fluid has a 10 minute-to-10 second gel ratio of 1.5:1 or less over a temperature range of 40° F. to 150° F.

10. The invert emulsion well bore fluid of claim 1, wherein the values of at least one of Yield Point, 10 minute gel, and 6 rpm is within +/−20% of the mean values across temperature ranges from 40° F. to 150° F.

11. The invert emulsion well bore fluid of claim 1, wherein the oleaginous fluid comprises from about 30% to about 100% by volume of the drilling fluid and the oleanginous fluid is selected from a group consisting of diesel oil, mineral oil, synthetic oil, esters, ethers, acetals, di-alkylcarbonates, olefins, and combinations thereof.

12. The invert emulsion drilling fluid of claim 1, wherein the non-oleaginous fluid comprises from about 1% to about 70% by volume of said drilling fluid and the non-oleaginous fluid is selected from the group consisting of fresh water, sea water, a brine containing organic or inorganic dissolved salts, a liquid containing water-miscible organic compounds, and combinations thereof.

13. The invert emulsion drilling fluid of claim 1, wherein the invert emulsion drilling fluid further comprises an organophilic clay.

14. The invert emulsion drilling fluid of claim 13, wherein the organophilic clay has a concentration of about 01. ppb to about 5 ppb.

15. The invert emulsion drilling fluid of claim 1, wherein the emulsifier has a concentration in the range of about 7 to about 11.

16. The invert emulsion drilling fluid of claim 1, wherein the rheology modifier has a concentration in the range of about 0.1 ppb to about 5 pbb.

17. A method of drilling a subterranean well comprising:
circulating an invert emulsion wellbore fluid in a well bore, wherein the invert emulsion well bore fluid comprises:
an oleaginous fluid, wherein the oleaginous fluid is the continuous phase of the well bore fluid;
a non-oleaginous fluid, wherein the non-oleaginous fluid is the discontinuous phase of the well bore fluid;
an emulsifier, wherein the emulsifier is an amidoamine formed from the reaction of a fatty acid with an alkylamine, wherein the fatty acid is selected from the group consisting of oleic acid, palmitic acid, linoleic acid, tall oil fatty acids (TOFA), and combinations thereof; and
a rheology modifier;
wherein the invert emulsion wellbore fluid has a flat rheology profile.

18. The method of claim 17, wherein the rheology modifier comprises a polyamine selected from the group consisting of diethylenetriamine, triethylenetetramine, tetraethylenepentamine, and combinations thereof.

19. The method of claim 17, wherein the rheology modifier comprises an alcoholamine selected from the group consisting of monoethanolamine, diethanolamine, and triethanolamine.

20. The method of claim 17, wherein the rheology modifier comprises a fatty acid that is a dimer or trimer fatty acid, or combinations thereof.

21. The method of claim 17, wherein the alkylamine is selected from the group consisting of diethylene triamine, triethylene tetramine, tetraethylene pentamine, and combinations thereof.

22. The method of claim 17, wherein the well bore fluid has a 10 minute-to-10 second gel ratio of 1.5:1 or less over a temperature range of 40° F. to 150° F.

23. The method of claim 17, wherein the values of at least one of Yield Point, 10 minute gel, and 6 rpm is within +/−20% of the mean values across temperature ranges from 40° F. to 150° F.

24. The method of claim 17, wherein the emulsifier has a concentration in the range of about 7 to about 11.

25. The method of claim 17, wherein the rheology modifier has a concentration in the range of about 0.1 ppb to about 5 pbb.

26. A well bore fluid comprising:
an oil base fluid;
an emulsifier, wherein the emulsifier is an amidoamine formed from the reaction of a fatty acid with an alkylamine, wherein the fatty acid is selected from the group consisting of oleic acid, palmitic acid, linoleic acid, tall oil fatty acids (TOFA), and combinations thereof; and
a rheology modifier, wherein the rheology modifier is a polyamide formed by the reaction of a polyamine with the reaction product of an alcoholamine and a fatty acid;
wherein the well bore fluid has a flat rheology profile.

27. The well bore fluid of claim 26, wherein the oil base fluid is selected from a group consisting of diesel oil, mineral oil, synthetic oil, esters, ethers, acetals, di-alkylcarbonates, olefins, and combinations thereof.

28. The well bore fluid of claim 26, wherein the oil base fluid is an invert emulsion, wherein
the continuous phase comprises from about 30% to about 100% by volume of the well bore fluid and the oleanginous fluid is selected from a group consisting of diesel oil, mineral oil, synthetic oil, esters, ethers, acetals, di-alkylcarbonates, olefins, and combinations thereof; and
the discontinuous phase comprises from about 1% to about 70% by volume of said drilling fluid and the non-oleaginous fluid is selected from the group consisting of fresh water, sea water, a brine containing organic or inorganic dissolved salts, a liquid containing water-miscible organic compounds, and combinations thereof.
